(19) United States
(12) Patent Application Publication
(10) Pub. No.: US 2004/0164152 A1
(43) Pub. Date: Aug. 26, 2004

(54) Optical image scanning with user adjustable object plane

(76) Inventors: Kevin J. Youngers, Greeley, CO (US); Rodney C. Harris, Fort Collins, CO (US); Kurt E. Spears, Fort Collins, CO (US); Robert G. Gann, Bellvue, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/369,959

(22) Filed: Feb. 20, 2003

(51) Int. Cl. G06K 7/10; G06K 7/14

(52) U.S. Cl. 235/454

(57) ABSTRACT

Object plane user selection in an optical image scanner is provided. One embodiment is a method for optically scanning a document comprising receiving a user selection of an object plane to be scanned, the user selection defining a distance above a platen, and adjusting an optical head based on the user selection to scan the object plane selected by the user.

### BACKGROUND

Optical image scanners, also known as document scanners, convert a visible image (e.g., on a document or photograph, an image in a transparent medium, etc.) into an electronic form suitable for copying, storing, or processing by a computer. An optical image scanner may be a separate device, or an image scanner may be a part of a copier, part of a facsimile machine, or part of a multipurpose device. Reflective image scanners typically have a controlled source of light, and light is reflected off the surface of a document, through an optics system, and onto an array of photosensitive devices (e.g., a charge-coupled device, complimentary metal-oxide semiconductor (CMOS), etc.). Transparency image scanners pass light through a transparent image, for example a photographic positive slide, through optics, and then onto an array of photosensitive devices. The optics focus at least one line, called a scanline, of the image being scanned, onto the array of photosensitive devices. The photosensitive devices convert received light intensity into an electronic signal. An analog-to-digital converter converts the electronic signal into computer readable binary numbers, with each binary member representing an intensity value.

There are two common types of image scanners. In a first type, a single spherical reduction lens system is commonly used to focus the scanline onto the photosensor array, and the length of the photosensor array is much less than the length of the scanline. In a second type, an array of many lenses is used to focus the scanline onto the photosensor array, and the length of the photosensor array is the same length as the scanline. For the second type, it is common to use Selfoc® lens arrays (SLA) (available from Nippon Sheet Glass Co.), in which an array of rod-shaped lenses is used, typically with multiple photosensors receiving light through each individual lens.

Depth of focus refers to the maximum distance that the object position may be changed while maintaining a certain image resolution (i.e., the amount by which an object plane may be shifted along the optical path with respect to some reference plane and introduce no more than a specified acceptable blur). The depth of focus for lens arrays is typically relatively short in comparison to scanners using a single spherical reduction lens system. Typically, flat documents are forced by a cover against a transparent platen for scanning, so depth of focus is not a problem. However, there are some situations in which the surface being scanned cannot be placed directly onto a platen. One example is scanning 35 mm slides. A typical frame for a 35 mm slide holds the surface of the film about 0.7-1.5 mm above the surface of the platen. As a result, slides may be slightly out of focus when using lens arrays that are focused at the surface of the platen. Another example is scanning books or magazines where part of a page being scanned curves into a binding spline, causing part of the surface being scanned to be positioned above the transparent platen. A large depth of focus is needed to sharply image the binding spline.

### SUMMARY

Embodiments of the present invention enable a user of an optical image scanner to adjust the object plane to be scanned.

One embodiment comprises a method for optically scanning a document comprising receiving a user selection of an object plane to be scanned, the user selection defining a distance above a platen, and adjusting an optical head based on the user selection to scan the object plane selected by the user.

Another embodiment comprises an optical image scanner comprising a means for receiving a user selection of an object plane to be scanned, the user selection defining a distance above a platen, and a means for adjusting an optical head based on the user selection to scan the object plane selected by the user.

Briefly described, another optical image scanner comprises a platen, an optical head for scanning, and an object plane controller configured to receive a user selection of an object plane to be scanned and control the manner in which the optical head is to be adjusted to scan the object plane selected.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a cross-sectional view of an embodiment of an optical image scanner according to the present invention.

FIG. 2 is a block diagram of a cross-sectional view of another embodiment of an optical image scanner according to the present invention.

FIG. 3 is a block diagram of a cross-sectional view of a further embodiment of an optical object scanner according to the present invention.

FIG. 4 is a flowchart illustrating the architecture, operation, and/or functionality of an embodiment of an object plane controller such as is shown in FIGS. 1-3.

FIG. 5 illustrates a top view of an optical image scanner such as is shown in FIGS. 1-3.

FIG. 6 is a more detailed block diagram of the optical image scanner of FIG. 5.

FIG. 7 is a block diagram of an optical image scanner such as is shown in FIGS. 1-3, which illustrates one of a number of implementations of an object plane controller.

### DETAILED DESCRIPTION

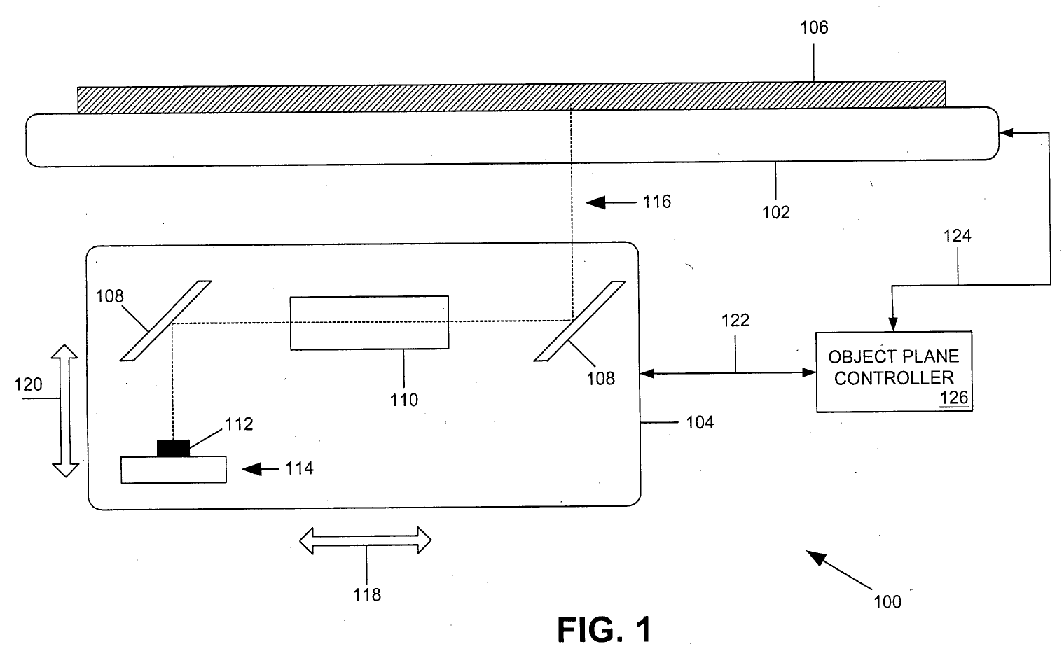

FIG. 1 is a block diagram of a cross-sectional view of an embodiment of an optical image scanner 100 including an object plane controller 126. The architecture, operation, and functionality of various embodiments of object plane controller 126 is described below in detail. However, by way of introduction, the general architecture, operation, and functionality is briefly described. In general, object plane controller 126 enables a user of optical image scanner 100 to adjust the object plane to be scanned by optical head 104. In other words, object plane controller 126 enables a user to adjust for variations in the height above platen 102 when scanning various targets (e.g., document 106, paper, negatives, transparencies, 35 mm slides, magazines, books, etc.). As described in more detail below, adjustments to the object plane (based on input from a user) may be accomplished in a number of ways. The particular adjustment modality used is not critical.

The relative sizes of various objects in FIG. 1 are exaggerated to facilitate illustration. As shown in FIG. 1, optical image scanning environment 100 comprises an optical head 104 (also known as a carriage) positioned relative to a transparent platen 102. As known in the art, a document 106 may be placed on the top surface of the platen 102 for scanning. Optical scanning environment 100 may be included within an optical image scanner (e.g., a low profile flatbed scanner), a facsimile machine, copier, etc.

As further illustrated in FIG. 1, optical head 104 comprises a first reflective surface 108 (e.g., mirror, etc.), a lens array 110, a second reflective surface 108, and an image sensor module 114. Image sensor module 114 may comprise, for example, a printed circuit assembly or any other semiconductor device. Image sensor module 114 also includes a photosensor array 112, which may be any type of device configured to receive optical signals and convert the light intensity into an electronic signal. For example, as known in the art, photosensor array 112 may comprise a charge-coupled device (CCD), complimentary metal-oxide semiconductor (CMOS), etc.

Lens array 110 may comprise an array of rod-shaped lenses which have a relatively short depth of focus. For example, lens array 110 may comprise a Selfoc® lens array (SLA), which is manufactured and sold by Nippon Sheet Glass Co. of Somerset, N.J. A rod-lens array may comprise at least one row of graded-index micro lenses, which may be equal in dimensions and optical properties. The lenses may be aligned between two fiberglass-reinforced plastic (FRP) plates. Because FRP has a coefficient of thermal expansion equal to glass, thermal distortion and stress effects are minimal. The FRP also increases mechanical strength of the SLA. The interstices may be filled with black silicone to prevent flare (crosstalk) between the lenses and protect each individual lens.

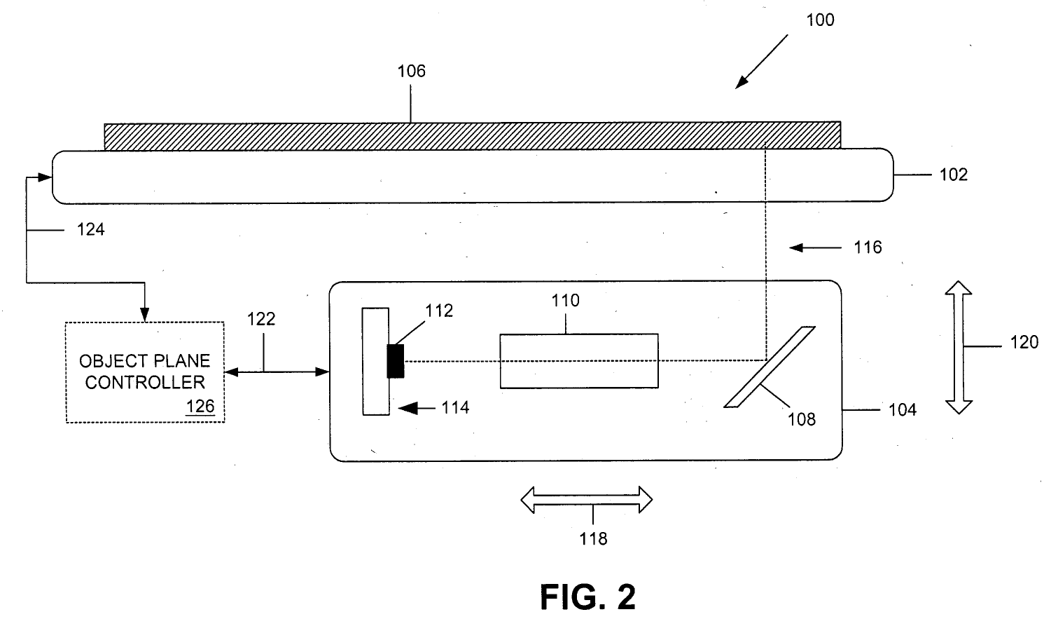

Referring again to FIG. 1, as a document 106 is being scanned by optical head 104, an optical signal 116 is reflected off the document 106 and towards the first reflective surface 108. The first reflective surface 108 directs the optical signal 116 through the lens array 110 to be focused. The optical signal 116 may also be reflected toward image sensor module 114 by a second reflective surface 108. The optical signal 116 is received by photosensor array 112 and converted into an electronic signal, which may be processed by an analog-to-digital converter, digital signal processor, etc. In this manner, the optics within optical head 104 focus a portion of an image of document 106 onto photosensor array 112. As illustrated in FIG. 2, the second reflective surface 108 may be optional. For instance, in order to alter the cross-sectional profile of optical head 104, second reflective surface 108 may be removed and the image sensor module 114 may be oriented perpendicular to the optical axis of lens array 110 to receive optical signal 116. Alternatively, the optical axis of lens array 110 may be oriented perpendicular to platen 102 to direct light through lens array and onto photosensor array 112. The particular orientation of lens array 110 is not relevant to the present invention.

The optical components within optical head 104 focus at least one line (i.e., a scanline) of the image being scanned onto photosensor array 112. As known in the art, scanning of the entire image may be accomplished by translating optical head 104 relative to document 106 (e.g., by using cables) as indicated by reference number 118.

As described in more detail below, optical image scanner 100 also comprises one or more mechanisms for adjusting the object plane to be scanned. For example, some mechanisms may adjust the location of the object plane by adjusting the optical head 104 relative to platen 102 (as indicated by reference number 120).

As mentioned above, due to the relatively small depth of focus of lens array 110, existing optical image scanners may produce blurred images or document 106 that are positioned a small distance above/below the primary focal point of lens array 110. For example, existing optical image scanners may be configured with the primary focal point at a relatively short distance Ho above the top surface of platen 102. When a document 106, such as a sheet of paper, etc. is positioned on platen 102, it may be located approximately the distance Ho above the top surface of platen 102 or within the relatively small range of the depth of focus. However, if the document 106 is positioned at an object plane that is outside of a range of acceptable focus, existing optical image scanners may produce a blurred image. For instance, various types of documents (or portions of the document) may be located at an object plane outside of the range of acceptable focus when positioned on platen 102 (e.g., 35 mm slides, transparencies, photographs, books, magazines, etc.).

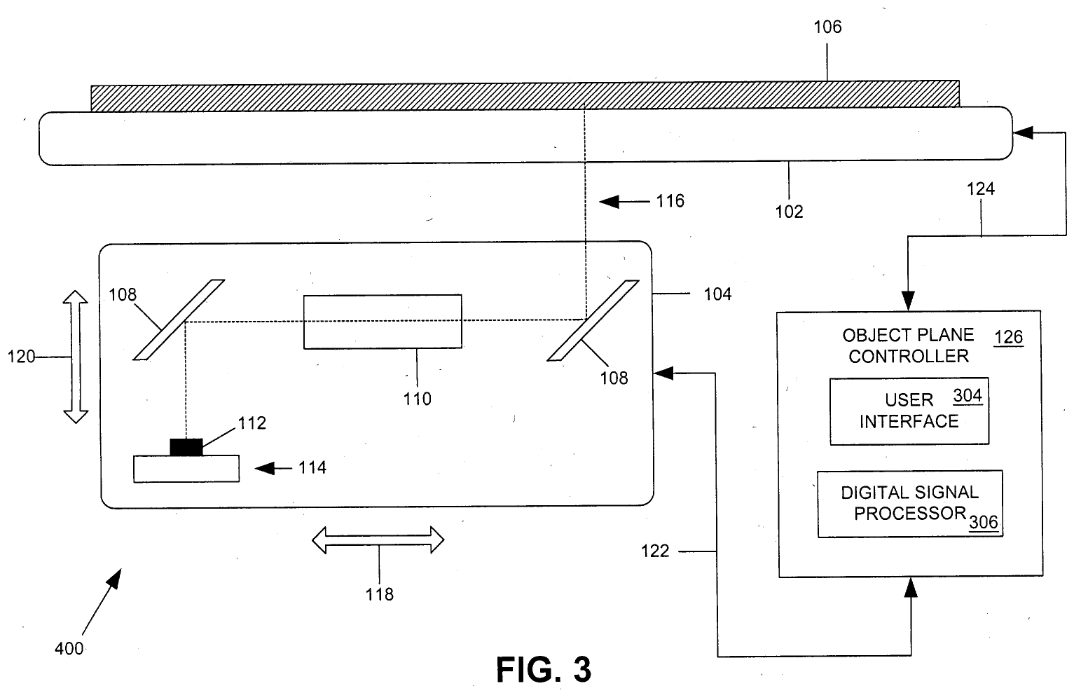

Having described a general overview of an optical image scanner 100, various systems and methods according to the present invention will be described with respect to FIGS. 3-7. FIG. 3 is a block diagram of a cross-sectional view of an embodiment of image scanner 100, according to the present invention, for enabling a user to adjust the object plane to be scanned by optical head 104.

As illustrated in FIG. 3, optical image scanner 100 further comprises an object plane controller 126, which is configured to receive a user selection of an object plane to be scanned and control the manner in which the optical head is to be adjusted to scan the object plane selected. In this embodiment, object plane controller 126 comprises a user interface 304 that communicates with various types of user controls (e.g., electronic display, object plane selection buttons, etc.). Object plane controller 126 may further comprise a processing device (e.g., digital signal processor 306) that communicates with optical head 104 via interface 122. The processing device may be configured to send commands to optical head 104 via interface 122. Object plane controller 126 may further communicate with various user controls via interface 124.

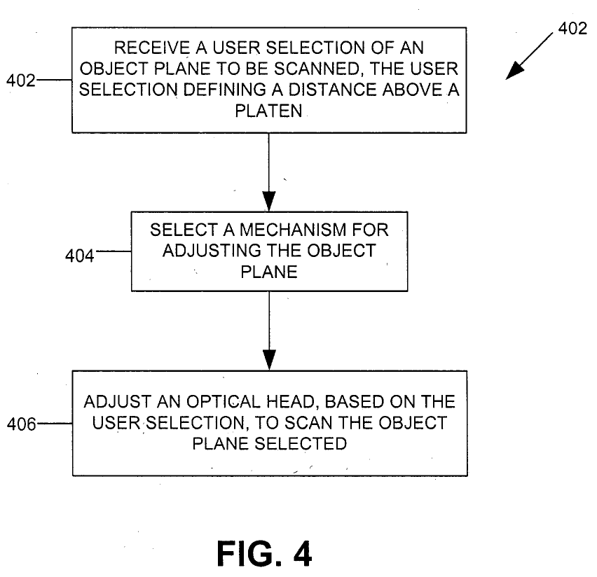

FIG. 4 is a flowchart illustrating the architecture, operation, and/or functionality of an embodiment of object plane controller 126. At block 402, object plane controller 126 may receive a user selection of an object plane to be scanned. For example, a user of optical image scanner may be scanning a 35 mm slide. As mentioned above, when placed on platen 102, the slide may be positioned at a higher object plane due to the slide edges. Optical image scanner 100 enables a user to specify that a 35 mm slide is being scanned and that the object plane should be adjusted accordingly.

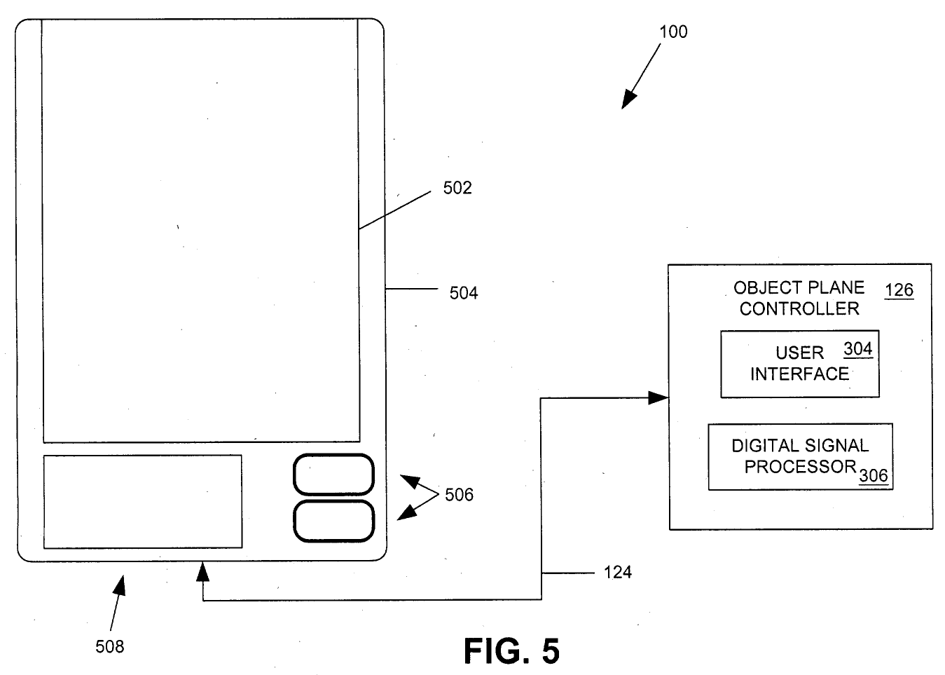

It should be appreciated that the user may make an object plane selection in a variety of ways. Referring to FIG. 5, optical image scanner 100 may comprise a housing 504 in which optical head 104 and object plane controller 126 reside. As known in the art, optical image scanner 100 may further comprise a hinged platen cover 502. During operation, a user may lift platen cover 502 to position an object 106 to be scanned on platen 102. Thus, it should be appreciated that the object plane selection may be made automatically when the user positions an object 106 on platen 102. For example, optical image scanner 100 may be configured to automatically determine that a 35 mm slide is positioned on platen 102. It should be appreciated that optical image scanner 100 may make this determination based on the size of document 106. Optical image scanner 100 may include various mechanical means, optical means, etc. to determine the type of object 106 positioned on platen 102. If optical image scanner 100 determines that a particular type of object 106 is positioned on platen 102, object plane controller 126 may automatically determine the distance above platen 102 at which the object plane should be located.

Referring again to FIG. 5, optical image scanner 100 may comprise various types of user controls (e.g., electronic display 508, selection buttons 506, etc.) that are configured to enable the user to specify the location of the object plane. As illustrated in FIG. 5, object plane controller 126 communicates with the user controls via interface 124. The user controls may be simple selection buttons 506 that merely specify the type of object 106 to be scanned. For example, one selection button 506 may correspond to a 35 mm slide. A user may press this button when a 35 mm slide is to be scanned. When a particular selection button 506 is pressed, object plane controller 126 may receive the selection and initiate the necessary adjustments to the location of the object plane above platen 102. The user controls may also be interactive (e.g., electronic display 508). In this embodiment, object plane controller 402 may be configured to support an interactive user interface. For example, object plane controller 126 may prompt the user for various types of information that may help identify the desirable object plane.

After receiving the user selection, at block 404, object plane controller 126 selects a particular mechanism for adjusting the location of the object plane above platen 102. As mentioned above, the particular adjustment modality is not critical for implementation of an embodiment of the present invention. In some embodiments, optical image scanner 100 may comprise one modality (e.g., adjusting the location of optical head 104 relative to platen 102). In other embodiments where multiple modalities are available, object plane controller 126 may determine an appropriate adjustment modality. At block 404, object plane controller 126 initiates the appropriate adjustment modality by sending a corresponding signal.

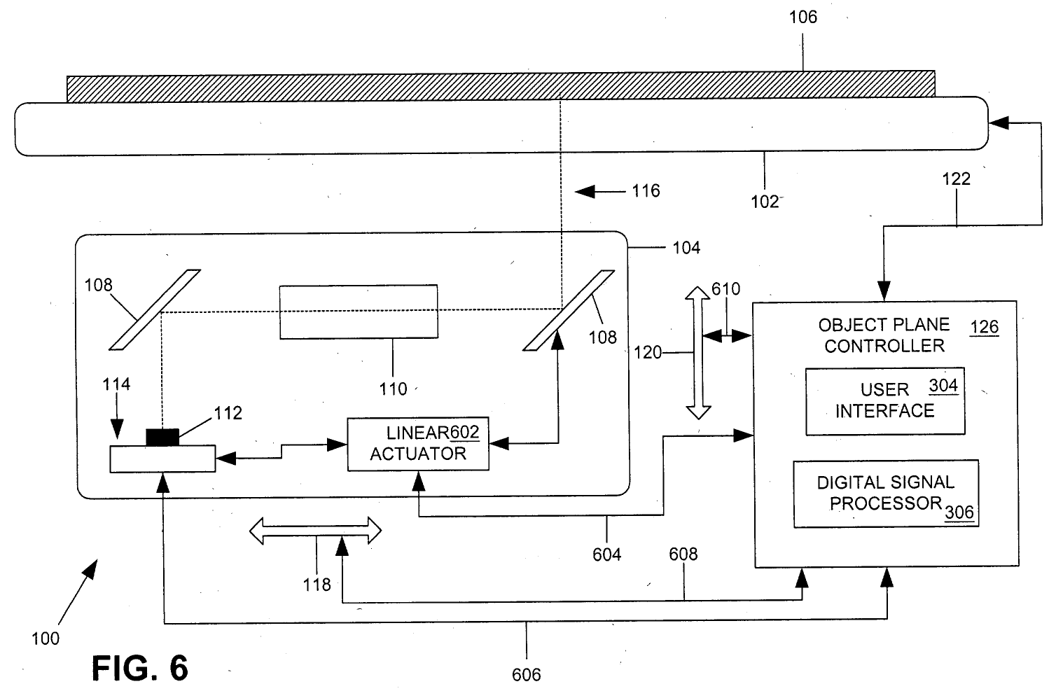

Referring to FIG. 6, various exemplary embodiments of adjustment modalities will be discussed. It should be appreciated that various other adjustment modalities may be employed. As stated above, optical image scanner 100 may include several types of mechanisms for adjusting the location of the object plane by adjusting the distance between optical head 104 and platen 102. One of many examples is described in commonly-assigned U.S. patent application Ser. No. 09/919,008, entitled “Optical Image Scanner With Adjustable Focus” and filed Jul. 31, 2001, which is hereby incorporated by reference in its entirety.

Other mechanisms for adjusting the distance between optical head 104 and platen 102 may be employed. For example, the object plane adjustment mechanism may be integrated with the mechanism that translates optical head 104 along the axis identified by reference numeral 118. Various mechanical means may be employed to adjust the distance between optical head 104 and platen 102 as the optical head is translated. Several examples are described in the following commonly-assigned and mutually-filed U.S. patent applications, which are each incorporated by reference in their entirety: U.S. patent application Ser. No. ______, entitled “End-of-Travel Focus Shift in an Optical Image Scanner;” U.S. patent application Ser. No. ______, entitled “End-of-Travel Focus Shift in an Optical Image Scanner.” In these embodiments, object plane controller 126 may initiate an appropriate adjustment (based on the user selection) by sending control signals via interface 608.

The location of the object plane above platen 102 may also be adjusted without having to reposition optical head 104 relative to platen 102. Instead of moving optical head 104, multiple object planes may be provided by modifying the internal optics of optical head 104. In this regard, optical head 104 may remain fixed relative to platen 102, while the internal optics are configured to provide multiple image object planes (i.e., primary focal point at various distances above the top surface of platen 102).

In one embodiment, the location of the object plane above platen 102 is adjusted by pivoting/moving a reflective surface 108. One example is described in commonly-assigned and mutually-filed U.S. patent application Ser. No. ______, entitled “Systems and Methods for Providing Multiple Object Planes in an Optical Image Scanner;” which is hereby incorporated by reference in its entirety. In this embodiment, object plane controller 126 initiates an appropriate adjustment (based on the user selection) by sending a control signal to a linear actuator 602 via interface 604. As shown in FIG. 6, the object plane may also be adjusted by pivoting/moving image sensor module 114.

In further embodiments, the location of the object plane above platen 102 may be adjusted by providing at least two photosensor arrays 112 on image sensor module 114 (i.e., a first photosensor array 112 for a first object plane and a second photosensor array 112 for a second object plane). The position of one photosensor array 112 may be shifted relative the other photosensor array 112. It will be appreciated that the differential in the optical path lengths between each photosensor array 112 and lens array 110 provides a proportional differential in the corresponding object planes. Several examples are described in commonly-assigned and mutually-filed U.S. patent application Ser. No. ______, entitled “Systems and Methods for Providing Multiple Object Planes in an Optical Image Scanner,” which is hereby incorporated by reference in its entirety.

In a further embodiment, optical image scanner 100 may be configured with at least two lens arrays 110 and corresponding photosensor arrays 112. Each lens array 110 and corresponding photosensor array 112 (i.e., lens array 110/photosensor array 112 pair) may be disposed in optical head 104 so that the photosensor array 112 is located at a unique object plane relative to platen 102. Several examples are described in commonly-assigned and mutually-filed U.S. patent application Ser. No. ______, entitled “Systems and Methods for Providing Object Planes in an Optical Image Scanner,” which is hereby incorporated by reference in its entirety.

In additional embodiments, multiple object planes relative to platen 102 may be provided by changing the effective distance of one optical path (between lens array 110 and photosensor array 112) relative to the other optical path (e.g., by inserting an optical delay element along one optical path, implementing a beam splitter, etc.). Several examples are described in commonly-assigned and mutually-filed U.S. patent application Ser. No. ______, entitled “Systems and Methods for Providing Multiple Object Planes in an Optical Image Scanning Environment,” which is hereby incorporated by reference in its entirety.

Where multiple photosensor arrays 112 are provided for the corresponding object planes, the object plane adjustment (based on the user selection) may be accomplished by selecting which photosensor array 112 to use for scanning. In this regard, object plane controller 126 may be configured to select which photosensor array 112 to use. Referring to FIG. 6, object plane controller 126 may send a control signal to image sensor module 114 via interface 606. Alternatively, object plane controller 126 may interface with an analog-to-digital converter.

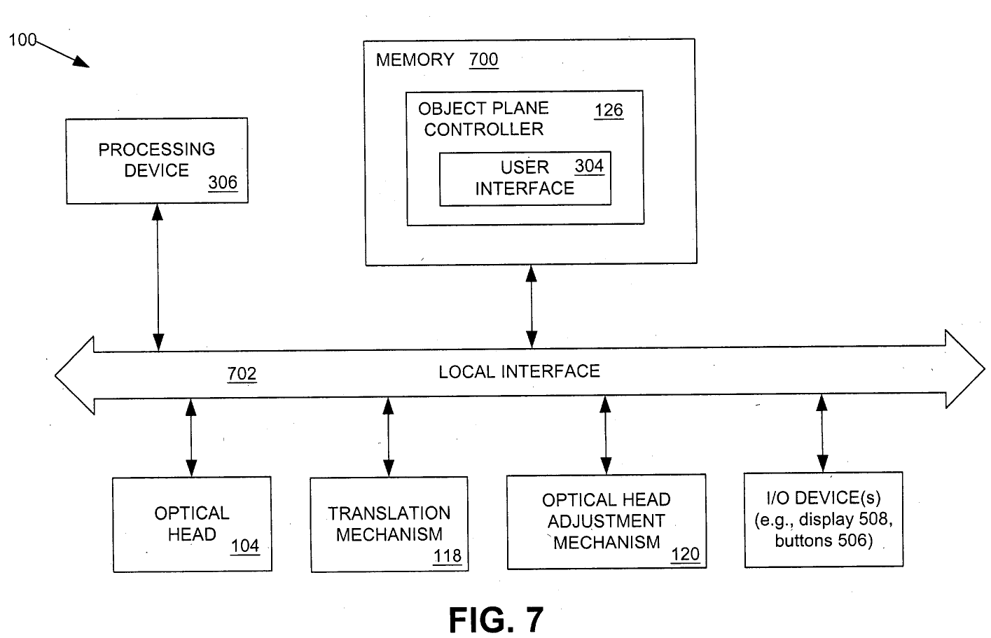

FIG. 7 is a block diagram of optical image scanner 100 illustrating one of a number of embodiments for implementing object plane controller 126. Optical image scanner 100 may comprise a processing device 306, memory 700, one or more input/output (I/O) devices (e.g., electronic display 508, buttons 506, etc.), optical head 104, translation mechanism 118, and optical head adjustment mechanism 120, each of which is connected to a local interface 702.

The processing device 306 can include any custom made or commercially-available processor, a central processing unit (CPU) or an auxiliary processor among several processors associated with optical image scanner 100, a semiconductor-based microprocessor (in the form of a microchip), a macroprocessor, one or more application-specific integrated circuits (ASICs), a plurality of suitably-configured digital logic gates, and other well known electrical configurations comprising discrete elements both individually and in various combinations to coordinate the overall operation of optical image scanner 100.

The memory 700 can include any one of a combination of volatile memory elements and nonvolatile memory elements. The memory 700 includes object plane controller 126. One of ordinary skill in the art will appreciate that the memory 700 may comprise other components which have been omitted for purposes of brevity.

The one or more user interface devices comprise those components with which the user can interact with optical image scanner 100. The I/O devices may include electronic display 508, buttons 506, other function keys, buttons, etc., a touch-sensitive screen, etc.

It should be appreciated that object plane controller 126 may be implemented in hardware, software, firmware, or any combination thereof. It is to be understood that this logic can be stored on any computer-readable medium for use by or in connection with any computer-related system or method. In the context of this document, a computer-readable medium denotes an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

One of ordinary skill in the art will appreciate that optical image scanner 100 may be configured in a variety of ways. For example, the second reflective surface 108 may be removed and image sensor module 114 positioned to receive optical signals 404 and 406 without being reflected (FIG. 2). Additional reflective surfaces 108 may also be added to achieve the same function. Furthermore, reflective surfaces 108 may be removed and the lens arrays 110 disposed so that a common optical axis is perpendicular to the surface of platen 102.

Therefore, having thus described the invention, at least the following is claimed:

1. A method for optically scanning a document, the method comprising:
receiving a user selection of an object plane to be scanned, the user selection defining a distance above a platen; and
adjusting an optical head based on the user selection to scan the object plane selected by the user.

2. The method of claim 1, wherein the adjusting an optical head comprises adjusting the distance between the optical head and the platen.

3. The method of claim 1, further comprising translating the optical head.

4. The method of claim 1, wherein the adjusting an optical head comprises selecting one of at least two photosensor arrays to use for scanning the object plane.

5. The method of claim 1, wherein the receiving a user selection comprises receiving a user selection via an electronic display.

6. The method of claim 1, wherein the receiving a user selection comprises determining the type of document to be scanned.

7. The method of claim 1, wherein the adjusting an optical head comprises pivoting an image sensor module so that a photosensor array is focused at a first distance above the platen and a photosensor array is focused at a second distance above the platen.

8. The method of claim 1, wherein the adjusting an optical head comprises adjusting the focal point above the platen.

9. The method of claim 1, wherein the adjusting an optical head comprises pivoting a reflective surface to focus at the object plane selected by the user.

10. An optical image scanner comprising:
a means for receiving a user selection of an object plane to be scanned, the user selection defining a distance above a platen; and
a means for adjusting an optical head based on the user selection to scan the object plane selected by the user.

11. The optical image scanner of claim 10, wherein the means for adjusting an optical head comprises a means for adjusting the distance between the optical head and the platen.

12. The optical image scanner of claim 10, further comprising a means for translating the optical head.

13. The optical image scanner of claim 10, wherein the means for adjusting an optical head comprises a means for selecting one of at least two photosensor arrays to use for scanning the object plane.

14. The optical image scanner of claim 10, wherein the means for receiving a user selection comprises an electronic display.

15. The optical image scanner of claim 10, wherein the means for adjusting an optical head comprises a means for pivoting an image sensor module so that a photosensor array is focused at a first distance above the platen and a photosensor array is focused at a second distance above the platen.

16. The optical image scanner of claim 10, wherein the means for adjusting an optical head comprises a means for adjusting the focal point relative to the platen.

17. An optical image scanner comprising
a platen;
an optical head for scanning; and
an object plane controller configured to receive a user selection of an object plane to be scanned and control the manner in which the optical head is to be adjusted to scan the object plane selected.

18. A computer program embodied in a computer-readable medium, comprising:
logic configured to receive a user selection of an object plane to be scanned, the user selection defining a distance above a platen; and
logic configured to adjust an optical head based on the user selection to scan the object plane selected by the user.

19. The computer program of claim 17, wherein the logic configured to adjust comprises logic configured to adjust the distance between the optical head and the platen.

20. The computer program of claim 17, wherein the logic configured to receive a user selection comprises logic oconfigured to receive a user selection via an electronic display.

21. The computer program of claim 17, wherein the logic configured to receive a user selection comprises logic configured to determine the type of document to be scanned.

22. The computer program of claim 17, wherein the logic configured to adjust an optical head comprises logic configured to pivot an image sensor module so that a photosensor array is focused at a first distance above the platen and a photosensor array is focused at a second distance above the platen.
